(19) United States
(12) Patent Application Publication
(10) Pub. No.: US 2021/0297380 A1
(43) Pub. Date: Sep. 23, 2021

(54) SYSTEM AND METHOD FOR DELIVERY AND RECEIPT OF ELECTRONIC COMMUNICATIONS

(71) Applicant: MARARLEE PTY LTD, Victoria (AU)

(72) Inventor: Robert Peter Hardy, Victoria (AU)

(73) Assignee: MARARLEE PTY LTD, Victoria, VI (AU)

(21) Appl. No.: 16/328,576

(22) PCT Filed: Jan. 30, 2018
(86) PCT No.: PCT/AU2018/050055

§ 371 Date: Feb. 26, 2019

(30) Foreign Application Priority Data
Mar. 3, 2017 (AU) 2017900744
Aug. 11, 2017 (AU) 2017903227
Nov. 21, 2017 (AU) 2017904706

(51) Int. Cl. H04L 12/58; H04L 29/12

(52) U.S. Cl. CPC H04L 51/20; H04L 61/609; H04L 51/28; H04L 51/18

(57) ABSTRACT

A system for sending one or more electronic messages include a predefined address format and the one or more intended recipients are associated with one or more fixed geographic locations. The system includes a sender user interface operable to enable a sender to create and send one or more electronic messages to one or more predefined message addresses. The system further includes a computer processor in communication with the sender user interface and configured to resolve the one or more predefined addresses with respective associated fixed geographic locations, and forward the one or more electronic messages to one or more electronic message accounts associated with the one or more predefined addresses. Further, one or more recipient user interfaces are operable to enable intended recipients, associated with one or more fixed geographic locations, to access multiple electronic messages sent to the message accounts associated with the recipient's fixed geographic location.

### CROSS-REFERENCE TO RELATED APPLICATIONS

This application is a U.S. National Phase of International Application No. PCT/AU2018/050055, filed Jan. 30, 2018, which claims priority to Australian Provisional Application No. 2017900744, filed Mar. 3, 2017, which claims priority to Australian Provisional Application No. 2017903227, filed Aug. 11, 2017, which claims priority to Australian Provisional Application No. 2017904706, filed Nov. 21, 2017 the disclosures of which are hereby incorporated by reference in their entirety.

### TECHNICAL FIELD

The present invention relates to a communications system and method for the delivery of electronic communications, to a fixed geographic location where one or more persons may be associated with that specified geographical location.

The present invention further relates to a communications system and method for the delivery of electronic communications (such as email), to a fixed geographic location where one or more persons may be associated with that specified geographical location. The present invention finds particular use in disseminating information (in electronic format) to persons residing at a fixed residential address, for example, a local Council advising residents of the details of a forthcoming local Council election, or a forthcoming event that will affect residents or occupants of a premises at one or more geographic locations.

### BACKGROUND OF INVENTION

Currently, there are only a few options or methods that are available for sending and/or receiving local emergency communications that may be of interest or relevance to a specific geographical location. Traditional emergency communications platforms, such as sirens, or radio and television broadcast have limitations.

However, non-traditional emergency communications platforms, such as social media and cellular based platforms also have limitations. Many segments of the public, for example, elderly, economically disadvantaged, non-English speakers do not typically use social media. Further, information gathered from social media users may be inaccurate and hoaxes are prevalent. Further still, information gathered that seems critical to public safety requires careful confirmation and multiple channels can overwhelm those tasked with monitoring social media.

Cellular based platforms, such as Cell Broadcast (CB) and Short Message Service (SMS), may enable a one-to-many geographically focused messaging service. A CB message page only comprises around 90 plain text characters. While up to 15 of these pages may be concatenated to form a longer CB message, it is not possible to send attachments such as evacuation maps and the like. There are also numerous handsets that do not have the capability to support CB messages. Another limitation is that users can switch the receiving of CB messages option off (as the CB functionality in a handset may lead to increased battery consumption). This means that operators have no means of knowing who is receiving the message. Further, there is a cost to setting up a CB centre used to compose and deliver the messages onto the mobile network for delivery to the handsets.

Similarly, SMS is a best-effort service with no delivery or performance guarantees. The message may not get through or may be delivered late. No priority is given to SMS, so emergency messages may get caught up in thousands of non-emergency messages (as significant events could exceed local capacity at individual cells). Further, SMS is not designed with security features or mechanisms creating a number of vulnerabilities including SPAM. Along these lines, SMS Spoofing is possible, potentially making messages appear as if they originated from official sources, when in fact they did not.

Further, there are only a few options or methods that are available for sending and/or receiving communications such as local Council information, local business information or any type of information that may be of interest or relevance to a particular household, workplace or person(s) residing or occupying a premises at a specific geographic location. A first option is sending, via a postal delivery system, hardcopy mail and notices to one or more residential or business addresses that correspond with various geographic locations. Alternatively, hardcopy mail and notices may be hand-delivered to one or more fixed residential or business addresses that correspond with various geographic locations. Another option is sending mail, in electronic format (i.e. an email) directly to one or more persons using known email addresses as for the intended recipients. A further, less popular option, is to post hardcopy notices on bulletin boards, such as community bulletin boards, or even in public spaces such as building fronts, fencing and even on trees or service poles within a geographic region. However, there are disadvantages associated with each one of the above described methods of disseminating information.

For instance, the option of sending, via the postal system, hardcopy mail to a specific location is a laborious task and requires many persons to co-ordinate and manage the delivery of hardcopy mail. This delivery method is also prone to human error and it is not uncommon for hardcopy mail addressed to a specific premises to be delivered to an incorrect location. Further, hardcopy mail is wasteful from a resource perspective and is not considered to be an environmentally friendly option in view of the paper and printing involved and is therefore undesirable.

Similarly, hardcopy information including notices and brochures that are either hand-delivered to residential or business premises, or posted to community bulletin boards, fences or service poles, is also wasteful from a resource perspective, and includes a high degree of uncertainty that persons who are intended recipients of the information have received the information and hence, this form of communication is also undesirable. With regard to the example of hand-delivered notices and brochures, due to the voluminous nature of such hardcopy information, a large proportion of residents tend to consider such information to be of little, or no relevance/interest and therefore generally discard such information without any consideration.

Whilst the option of sending by other electronic means, for example, as an email, avoids many disadvantages associated with the above emergency communications platforms, this delivery method nevertheless has the drawback that it is necessary to know the email address of persons at the specific geographical location. Since many people are reluctant to provide their email address to businesses or government (or any other unknown person or group) for privacy reasons, contact details for electronic communications for persons according to their location are not normally known.

The present invention attempts to address the abovementioned disadvantages associated with conventional methods and systems used to disseminate information electronically to person(s) residing at or that are otherwise associated with, a premises or fixed geographic location.

### SUMMARY OF INVENTION

According to a first aspect, the present invention provides a system for sending one or more electronic messages to one or more intended recipients each having access to an electronic communication device, the electronic messages having a predefined address format, the one or more intended recipients being associated with one or more fixed geographic locations, the system including: a sender user interface operable to enable a sender to create and send one or more electronic messages to one or more predefined message addresses; a computer processor in communication with the sender user interface and configured to: resolve the one or more predefined addresses with respective associated fixed geographic locations and forward the one or more electronic messages to one or more electronic message accounts associated with the one or more predefined addresses; one or more user recipient interfaces operable to enable intended recipients associated with one or more fixed geographic locations, to access the one or more electronic messages sent to the message accounts associated with the recipient's fixed geographic location.

It will be appreciated that in the context of the present invention, an electronic message includes, but is not limited to, any form of electronic communication such as electronic mail (e-mail).

It will also be appreciated that the predefined message addresses may be of any desired format, including a string of letters, a string of numbers, a string of characters or a combination of any one or more of a string of letters, numbers and/or characters. In an embodiment, the predefined message address may be the geographic coordinates of the fixed geographic location associated with the predefined message address. In an embodiment, the geographic coordinates are longitudinal and latitudinal coordinates.

The system may be a computer-implemented system which users (senders and recipients) may access via a data communications network such as the internet or the system may be an application associated with a particular device.

The system may be a separate or stand-alone application that provides all of the functional features or elements of the system, or alternatively, the system may be embedded within one or more external (third party) systems. Typical third party applications that are envisaged as being particularly suited for use in the system of the present invention are mapping applications such as Google or Bing maps.

The system of the invention according to an embodiment may be a single application or alternatively, may be a distributed application. In an embodiment, the system is publicly accessible. However, in other embodiments, the system may be a private application with restricted user access.

The sender and recipient user interfaces may be any conventional interface system that operates on a number of devices including, but not limited to, a personal computer, laptop, mobile phone or tablet, and one that allows a user (sender or recipient) to interact with and use the system of the invention. The user interface may also allow authentication of a user's details by requiring the user to enter, for example, a unique username and password in order to access the system.

In an embodiment, longitudinal and latitudinal geographic coordinates are used to associate a predefined message address with a fixed geographic location.

In an embodiment, the computer processor is able to resolve specific unit or apartment addresses located in multilevel buildings or residences

In an embodiment, the sender user interface is adapted to receive from the sender, a predefined message address in order to send an electronic message to one or more recipients residing in, or associated with, a fixed geographic location, wherein the one or more recipients have access to an account associated with a predefined message address and fixed geographic location.

In an embodiment, the fixed geographic location is a residence, for example, a house, apartment, unit or townhouse. In an embodiment, the fixed geographic location is non-residential, for example, a place of business, an educational institution, a library, a hospital, a police station, a church etc.

In an embodiment, the sender interface is adapted to receive from the sender, any one of, or a combination of two or more of, the following information: a plurality of predefined message addresses; one or more specified geographic regions including any one or more of the following: a street, a suburb, a postcode, a shire, a local council, a state, a region or a country; a specified distance from a fixed point location to define a geographic region. It will be appreciated that such information will enable a sender to select, in this embodiment, a plurality of fixed geographic locations, wherein each fixed geographic location is associated with a predefined message address.

In an embodiment, the sender is able to select a plurality of fixed geographic locations by the use of an electronic input device which is used to cast a virtual net over a selected geographic region, wherein each fixed geographic location is associated with a predefined message address.

In an embodiment, either one or both of the sender and recipient user interfaces is selected from a computer, a laptop, a tablet or a mobile communication device.

According to a second aspect, the present invention provides a computer-implemented method of sending electronic messages by a sender in relation to a fixed geographical location, the method including: the sender accessing an application through a user interface, wherein the application is configured to accept one or more inputs from the sender relating to the selection of one or more predefined message addresses to which the one or more electronic messages are to be sent; wherein each one or more predefined message addresses are associated with a fixed geographic location.

According to a third aspect, the present invention provides a computer-implemented method of receiving electronic messages relating to a fixed geographical location by one or more recipients residing in, or associated with, the fixed geographical location, the method including: one or more recipients accessing an account through a recipient user interface, wherein the one or more electronic messages relevant to the fixed geographic location is sent to, and received in, the recipient's account; wherein each fixed geographic location is associated with a predefined message address and each predefined message address is associated with the recipient's account.

In an embodiment, the one or more recipients must be registered to access the application associated with the system and method of the present invention. In an embodiment, the one or more recipients must also be authorised to access electronic messages relating to the fixed geographic location in which they reside or are otherwise associated with. It will be appreciated that a recipient, whilst not residing in a fixed geographic location, may nevertheless be associated with a fixed geographic location, for example, the fixed geographic location may be the recipient's place of business.

Alternatively, the recipient may be a landlord who prefers to receive any local Council notices that may affect their property. Accordingly landlords, whilst not residing in their tenanted property, may prefer to register to access and use the system of the invention in order to receive electronic messages relevant to their property. In this example, it will be appreciated that the tenants may also prefer to receive electronic messages relating to their place of residence and may therefore register, in addition to the landlord, to access and use the system of the invention in relation to the property.

In an embodiment, the one or more recipients are able to specify various criteria relating to the type and frequency of electronic messages permitted to be sent to, and therefore received by, their predefined message address. In an embodiment, such criteria may include, but are not limited to, electronic message type, electronic message frequency and the specification of any senders from which electronic messages are undesired (sometimes referred to as a “blocked” sender). For example, a recipient may prefer to receive official electronic communications such as Local Council notices, however, the recipient may prefer not to receive advertising material from local businesses. A recipient may also prefer to set the frequency in which electronic messages are received, either generally, or with specific reference to particular senders. A recipient may also prefer to “block”, or prevent, the transmission and receipt of certain electronic messages from specific senders.

A recipient may also set the date range within which electronic messages will be accepted for receipt from certain senders, or alternatively, set a date range within which various electronic communications will be retained, after the expiration of which, such electronic communications will be automatically deleted.

In an embodiment, the electronic messages may be automatically forwarded to a personal address of the one or more recipients residing in, or associated with, a fixed geographic location. Alternatively, the electronic messages may be stored and saved for an indefinite time, or a time set by the sender and/or recipient, in a memory location associated with the application to which the one or more recipients have access.

In another embodiment, recipients are provided with the facility to reply to an email message delivered to a fixed geographic location with which the recipient is associated. However, in this embodiment, any reply email is provided by default from the address pertaining to the fixed geographic location thereby retaining the privacy of the recipient's private email address. In another embodiment, the recipient is provided with the option to reveal their private email address to a sender so that future correspondence may occur by use of the recipient's private email address.

According to a fourth aspect, the present invention provides a computer readable medium storing one or more instructions that, when executed by one or more processors, cause the one or more processors to: receive, by a sender user interface, instructions for an application to accept one or more inputs from the sender relating to the selection of one or more predefined message addresses associated with a fixed geographic location.

According to a fifth aspect, the present invention provides a computer readable medium storing one or more instructions that, when executed by one or more processors, cause the one or more processors to: send, by a communications network, one or more electronic messages to an electronic message account associated with a predefined message address, wherein the each predefined message address is associated with a fixed geographic location.

According to a sixth aspect, the present invention provides a method comprising: receiving, from an electronic communication device and by a server, a request for accessing one or more emergency services; determining, by the server, a current geographic location of the electronic communication device; identifying, by the server, emergency information associated with an emergency service available at the geographic location; initiating communication between the electronic communication device and the emergency service using the identified emergency information; and communicating with the emergency service using the emergency information via one or more electronic messages, wherein communicating with the emergency service includes sending, from the server, the geographic location of the electronic communication device.

In an embodiment, the server may verify that the electronic communication device is actually located at the determined geographic location. It will be appreciated, that verifying that the electronic communication device is actually located at the geographic location may reduce a number of vulnerabilities of conventional electronic messaging including SPAM or spoofing that potentially allow messages to appear as if they originated from a particular geographic location, when in fact they did not.

In another embodiment, the geographic location of the electronic communication device may be stored as metadata in the electronic message.

In another embodiment, the longitudinal and latitudinal geographic coordinates may be used to associate the electronic message with the geographic location.

In another embodiment, geographic coordinates received from the electronic communications device may be resolved as a postal address associated with a user.

In another embodiment, the emergency information may comprise at least one of an email address, an identifier of a text message service, or a cell broadcast message service.

According to a seventh aspect, the present invention provides a system for sending one or more electronic messages to one or more intended recipients comprising: one or more processors; and a computer-readable medium storing instructions for execution by the one or more processors, the instructions operable to cause the one or more processors to perform operations comprising: receiving, from an electronic communication device and by a server, a request for accessing one or more emergency services; determining, by the server, a current geographic location of the electronic communication device; identifying, by the server, emergency information associated with an emergency service available at the geographic location; initiating communication between the electronic communication device and the emergency service using the identified emergency information; and communicating with the emergency service using the emergency information via one or more electronic messages, wherein communicating with the emergency service includes sending, from the server, the geographic location of the electronic communication device.

In an embodiment, the server may verify that the electronic communication device is actually located at the determined geographic location.

In another embodiment, the geographic location of the electronic communication device may be stored as metadata in the electronic message.

In another embodiment, the longitudinal and latitudinal geographic coordinates may be used to associate the electronic message with the geographic location.

In another embodiment, geographic coordinates received from the electronic communications device may be resolved as a postal address associated with a user.

In another embodiment, the emergency information may comprise at least one of an email address, an identifier of a text message service, or a cell broadcast message service.

According to an eighth aspect, the present invention provides a system for sending one or more electronic messages to one or more intended recipients each having access to an electronic communication device, the electronic messages having a predefined address format, the one or more intended recipients being associated with one or more fixed geographic locations, the system including: a sender user interface operable to enable a sender to create and send one or more electronic messages to one or more predefined message addresses; a computer processor in communication with the sender user interface and configured to: resolve the one or more predefined addresses with respective associated fixed geographic locations and forward the one or more electronic messages to one or more electronic message accounts associated with the one or more predefined addresses; one or more user recipient interfaces operable to enable intended recipients associated with one or more fixed geographic locations, to access the one or more electronic messages sent to the message accounts associated with the recipient's fixed geographic location.

It will be appreciated that in the context of the present invention, an electronic message includes, but is not limited to, any form of electronic communication such as electronic mail (e-mail).

It will also be appreciated that the predefined message addresses may be of any desired format, including a string of letters, a string of numbers, a string of characters or a combination of any one or more of a string of letters, numbers and/or characters. In an embodiment, the predefined message address may be the geographic coordinates of the fixed geographic location associated with the predefined message address. In an embodiment, the geographic coordinates are longitudinal and latitudinal coordinates.

The system may be a computer-implemented system which users (senders and recipients) may access via a data communications network such as the internet or the system may be an application associated with a particular device.

The system may be a separate or stand-alone application that provides all of the functional features or elements of the system, or alternatively, the system may be embedded within one or more external (third party) systems. Typical third party applications that are envisaged as being particularly suited for use in the system of the present invention are mapping applications such as Google or Bing maps.

The system of the invention according to an embodiment may be a single application or alternatively, may be a distributed application. In an embodiment, the system is publicly accessible. However, in other embodiments, the system may be a private application with restricted user access.

The sender and recipient user interfaces may be any conventional interface system that operates on a number of devices including, but not limited to, a personal computer, laptop, mobile phone or tablet, and one that allows a user (sender or recipient) to interact with and use the system of the invention. The user interface may also allow authentication of a user's details by requiring the user to enter, for example, a unique username and password in order to access the system.

In an embodiment, longitudinal and latitudinal geographic coordinates are used to associate a predefined message address with a fixed geographic location.

In an embodiment, the computer processor is able to resolve specific unit or apartment addresses located in multilevel buildings or residences

In an embodiment, the sender user interface is adapted to receive from the sender, a predefined message address in order to send an electronic message to one or more recipients residing in, or associated with, a fixed geographic location, wherein the one or more recipients have access to an account associated with a predefined message address and fixed geographic location.

In an embodiment, the fixed geographic location is a residence, for example, a house, apartment, unit or townhouse. In an embodiment, the fixed geographic location is non-residential, for example, a place of business, an educational institution, a library, a hospital, a police station, a church etc.

In an embodiment, the sender interface is adapted to receive from the sender, any one of, or a combination of two or more of, the following information: a plurality of predefined message addresses; one or more specified geographic regions including any one or more of the following: a street, a suburb, a postcode, a shire, a local council, a state, a region or a country; a specified distance from a fixed point location to define a geographic region. It will be appreciated that such information will enable a sender to select, in this embodiment, a plurality of fixed geographic locations, wherein each fixed geographic location is associated with a predefined message address.

In an embodiment, the sender is able to select a plurality of fixed geographic locations by the use of an electronic input device which is used to cast a virtual net over a selected geographic region, wherein each fixed geographic location is associated with a predefined message address.

In an embodiment, the computer processor is further adapted to automatically populate an electronic message with the predefined message addresses corresponding to any fixed geographic locations selected by the sender.

In an embodiment, either one or both of the sender and recipient user interfaces is selected from a computer, a laptop, a tablet or a mobile communication device.

According to a ninth aspect, the present invention provides a computer-implemented method of sending electronic messages by a sender in relation to a fixed geographical location, the method including: the sender accessing an application through a user interface, wherein the application is configured to accept one or more inputs from the sender relating to the selection of one or more predefined message addresses to which the one or more electronic messages are to be sent; wherein each one or more predefined message addresses are associated with a fixed geographic location.

According to a tenth aspect, the present invention provides a computer-implemented method of receiving electronic messages relating to a fixed geographical location by one or more recipients residing in, or associated with, the fixed geographical location, the method including: one or more recipients accessing an account through a recipient user interface, wherein the one or more electronic messages relevant to the fixed geographic location is sent to, and received in, the recipient's account; wherein each fixed geographic location is associated with a predefined message address and each predefined message address is associated with the recipient's account

In an embodiment, the one or more recipients must be registered to access the application associated with the system and method of the present invention. In an embodiment, the one or more recipients must also be authorised to access electronic messages relating to the fixed geographic location in which they reside or are otherwise associated with. It will be appreciated that a recipient, whilst not residing in a fixed geographic location, may nevertheless be associated with a fixed geographic location, for example, the fixed geographic location may be the recipient's place of business.

Alternatively, the recipient may be a landlord who prefers to receive any local Council notices that may affect their property. Accordingly landlords, whilst not residing in their tenanted property, may prefer to register to access and use the system of the invention in order to receive electronic messages relevant to their property. In this example, it will be appreciated that the tenants may also prefer to receive electronic messages relating to their place of residence and may therefore register, in addition to the landlord, to access and use the system of the invention in relation to the property.

In an embodiment, the one or more recipients are able to specify various criteria relating to the type and frequency of electronic messages permitted to be sent to, and therefore received by, their predefined message address. In an embodiment, such criteria may include, but are not limited to, electronic message type, electronic message frequency and the specification of any senders from which electronic messages are undesired (sometimes referred to as a “blocked” sender). For example, a recipient may prefer to receive official electronic communications such as Local Council notices, however, the recipient may prefer not to receive advertising material from local businesses. A recipient may also prefer to set the frequency in which electronic messages are received, either generally, or with specific reference to particular senders. A recipient may also prefer to “block”, or prevent, the transmission and receipt of certain electronic messages from specific senders.

A recipient may also set the date range within which electronic messages will be accepted for receipt from certain senders, or alternatively, set a date range within which various electronic communications will be retained, after the expiration of which, such electronic communications will be automatically deleted.

In an embodiment, the electronic messages may be automatically forwarded to a personal address of the one or more recipients residing in, or associated with, a fixed geographic location. Alternatively, the electronic messages may be stored and saved for an indefinite time, or a time set by the sender and/or recipient, in a memory location associated with the application to which the one or more recipients have access.

In another embodiment, recipients are provided with the facility to reply to an email message delivered to a fixed geographic location with which the recipient is associated. However, in this embodiment, any reply email is provided by default from the address pertaining to the fixed geographic location thereby retaining the privacy of the recipient's private email address. In another embodiment, the recipient is provided with the option to reveal their private email address to a sender so that future correspondence may occur by use of the recipient's private email address.

According to a eleventh aspect, the present invention provides a computer readable medium storing one or more instructions that, when executed by one or more processors, cause the one or more processors to: receive, by a sender user interface, instructions for an application to accept one or more inputs from the sender relating to the selection of one or more predefined message addresses associated with a fixed geographic location.

According to a twelfth aspect, the present invention provides a computer readable medium storing one or more instructions that, when executed by one or more processors, cause the one or more processors to: send, by a communications network, one or more electronic messages to an electronic message account associated with a predefined message address, wherein the each predefined message address is associated with a fixed geographic location.

### BRIEF DESCRIPTION OF DRAWINGS

Embodiment(s) of the invention will now be described in further detail with reference to the accompanying figure(s) in which:

FIG. 1 provides a conceptual illustration of a system and method according to an embodiment of the invention in which a sender creates an electronic message, and sends same to a predefined message address associated with a fixed geographic location, for retrieval by a recipient residing in, or associated with, the fixed geographic location.

FIG. 2 provides a conceptual illustration detailing the registration and maintenance of a recipient account according to the embodiment of FIG. 1.

FIG. 3A provides a conceptual illustration of the creation and sending of electronic messages by a sender according to the embodiment of FIG. 1.

FIG. 3B provides a conceptual illustration of an alternative method of populating an electronic message with one or more predefined message addresses associated with fixed geographic locations, according the embodiment of FIG. 1.

FIG. 4 provides a conceptual illustration of the components of the system application according to the embodiment of FIG. 1.

FIG. 5 illustrates a table of possible scenarios in which a plurality of recipients are able to receive electronic messages associated with a fixed geographic location, or alternatively, a recipient may receive electronic messages associated with a plurality of fixed geographic locations according to an embodiment of FIG. 1.

FIG. 6 provides a conceptual illustration detailing the steps by which a recipient receives electronic messages according to the embodiment of FIG. 1.

FIG. 7 provides a conceptual illustration of how the system and method according to the embodiment of FIG. 1 may be utilised to send one or more electronic messages to a plurality of predefined message addresses associated with fixed geographic locations.

FIG. 8 provides a flow diagram illustrating a process for communicating location-based emergency information to an emergency service according to an embodiment of the invention.

### DETAILED DESCRIPTION

For convenience, the invention will be described with respect to a particular embodiment. However, it will be appreciated by those skilled in the art that the invention is not limited to any of the embodiments described.

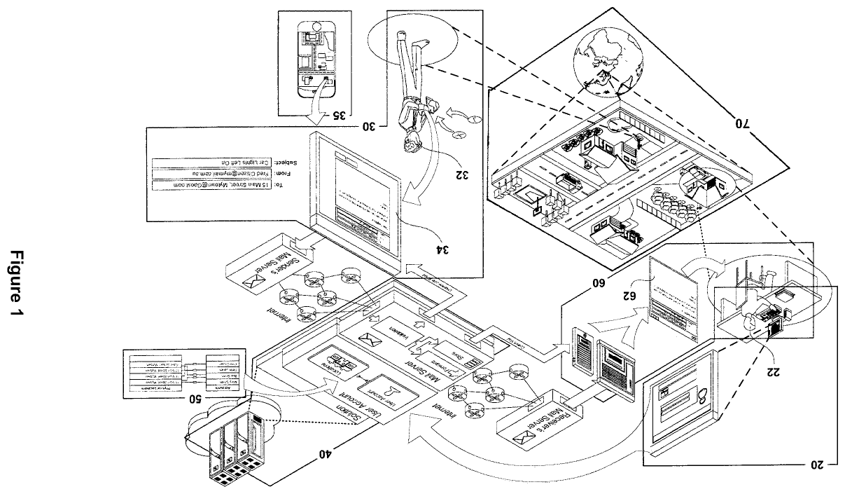

With reference to FIG. 1, a diagrammatic representation of an example system and method according to a first embodiment of the invention is illustrated in which a sender creates an electronic communication, and sends same to a dedicated geographic electronic mail client with the intended recipient identified in accordance with a predefined address format where the electronic mail address is associated with a fixed geographic location for retrieval by a receiver residing in, visiting, or associated with, the fixed geographic location.

The present invention finds particular use in disseminating emergency information (in electronic format) to persons residing at a fixed residential address, venue, for example a campus or complex of a university, company, or government entity, for example a government advising residents of an emergency, that will affect residents or occupants of a venue at one or more geographic locations.

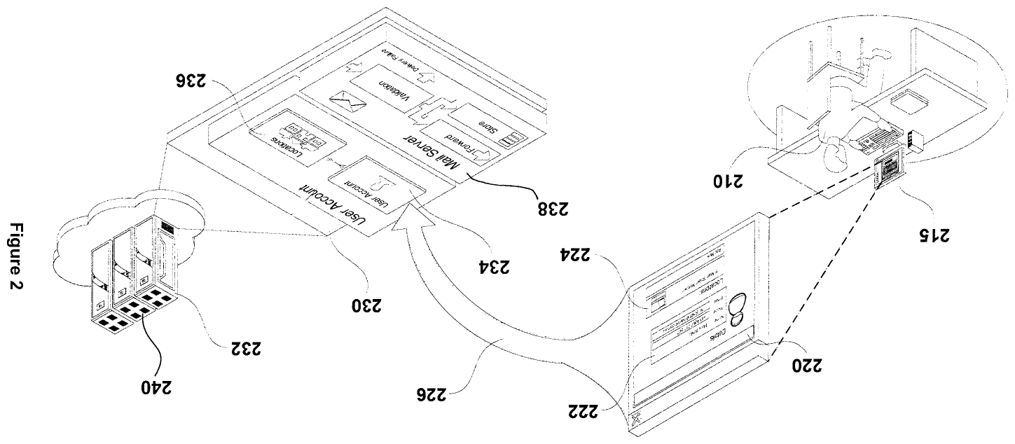

All of the components illustrated in FIG. 1 are represented in greater detail in subsequent FIGS. 2 to 6 and the primary components of the system illustrated in FIG. 1 are described below.

The components encircled with fixed outline 20 are the components associated with the registration process that enables users to register their electronic mail contact details and identify the fixed geographic location with which they are associated. Registration of a user with the dedicated geographic email client enables the user to receive/access email correspondence directed to an email account associated with the fixed geographic location.

The components encircled with fixed outline 30 are the components involved in the process of creating, or composing, an electronic mail message using either a standard email client or the dedicated geographic email client of the embodiment. The components in this section of FIG. 1 also illustrate a sender's user interface in which the sender includes an email address according to a predefined address format for transmitting the electronic mail message to an email account associated with the fixed geographic location to which the sender seeks to send an electronic mail message.

The components encircled by fixed outline 35 illustrate the components for an alternative process for composing an email message in which the sender initiates an email client on a mobile electronic communication device such as a Smartphone or a computer tablet and the dedicated geographic email client assists the sender to determine the fixed geographic location to which the sender seeks to transmit an electronic mail message. This is effected by a mapping application that enables the sender to identify the fixed geographic locations by reference to the mapping application.

The components encircled by fixed outline 40 illustrate components of the system that receive sender requests regarding email messages and performs a range of functions including storing electronic mail messages in email accounts associated with fixed geographic locations to which an email message is addressed and further processing the electronic mail message by either storing, or forwarding, the email message for access by an intended recipient or, in the event that the electronic mail message is undeliverable, providing an appropriate message to the sender. This component of the system performs a range of additional functions including management of user accounts, resolving predefined addresses with respective fixed geographic locations and the storage and processing of user preferences in relation to users who have registered their electronic message contact details for receipt of email messages transmitted to a fixed geographic location with whom the user is associated.

The component illustrated in the encircled fixed outline 50 are examples of relationships that may exist between electronic message accounts and fixed geographic locations.

The components illustrated within the fixed outline 60 illustrate those components that process electronic mail messages for an intended recipient and in this regard, the intended recipient either receives the email message by the forwarding of same to their private email account or, the intended recipient may collect the email message by accessing the account associated with the fixed geographic location associated with the intended recipient for the purpose of viewing the electronic mail message.

The objects encircled by fixed outline 70 illustrate fixed geographic locations of both the sender and the intended recipient which, in the example of FIG. 1, the sender and the intended recipient are each associated with a particular geographic location that are located directly opposite one another somewhere in the world (e.g. a government department responsible consular assistance and a traveller).

With reference to FIG. 2, a diagrammatic illustration is provided of a user (210) seeking to receive electronic mail messages transmitted to a fixed geographic location with whom the user is associated and in the example of FIG. 2, the user (210) is performing a registration process using their personal computer (215) such that they can access, or receive, electronic mail messages transmitted to the fixed geographic location with which they have some form of association.

In this regard, the association of the user (210) with a fixed geographic location may include the user (210) occupying a residence at the fixed geographic location, or the user (210) may occupy a fixed geographic location during office hours such as a business premises. Further, the user (210) may be the owner of a residence at a fixed geographic location and may be a landlord with tenants residing in the premises located at the fixed geographic location.

In any event, the user (210) initiates a registration process and provides some form of verification that they have the authority to receive email messages transmitted to the fixed geographic location. This process will likely vary from country to country and in some instances may include submitting evidence to the system that the user (210) has the requisite authority to receive email messages directed to a fixed geographic location by adducing documents evidencing the payment of council rates or perhaps providing an extract from the Land Titles Office which records the owner of residences and premises at fixed geographic locations. Advantageously, this process provides security to the system. Of course, as part of this process, the user (210) should also verify their identity and this may be effected by a range of processes including well established proof of identity procedures which may involve the transmission of Out Of Band (00B) messages to the user's (210) Smartphone with a password or some other code requiring entry during the registration process to verify that the individual performing the registration process has the identity indicated during that registration process.

During this process, the user (210) is provided with a user interface (220) and the user (210) completes various fields identified within the user interface (220) including details such as a private email address to which the user would prefer incoming email messages to be forwarded (222) and of course, provision of the details of one or more physical address(es) for which the user (210) has the authority to collect email messages directed to the one or more physical addresses at fixed geographic locations (224).

Once the user (210) has completed all of the required fields in the user interface (220), the details are transmitted (226) to a computer server (230) which includes one or more computer applications.

In the example of FIG. 2, component (232) is the infrastructure on which the present invention operates and may be a local or cloud based infrastructure. Component (232) includes a series of sub-components a server (230) which executes a number of computer applications to effect functions such as creating and administering user accounts (234), retaining and maintaining a database of fixed geographic locations and the users associated with each of those fixed geographic locations (236). As will be appreciated by skilled readers, it is possible to have a “many-to-many” relationship between user accounts and fixed geographic locations at which residences and/or premises are located. As will also be appreciated by, it is also possible to have a relationship between user accounts and geographic locations they are visiting or passing through. In this way, users can receive messages that are only relevant to that location. Advantageously, this results in bandwidth savings in contrast to traditional delivery methods. Bandwidth loading on the network is managed by pushing electronic messages to only relevant recipients (one problem with large networks where the clients are connected at all times is the large amount of network traffic due to frequent email checks that users make, or, more typically, that the users' device makes on the users' behalf to see if there are any new messages waiting for them on a mail server, for example). Optionally, component (232) may further include location verification component (240) which is be provided to verify the location of a user who, for example, wishes to send mail.

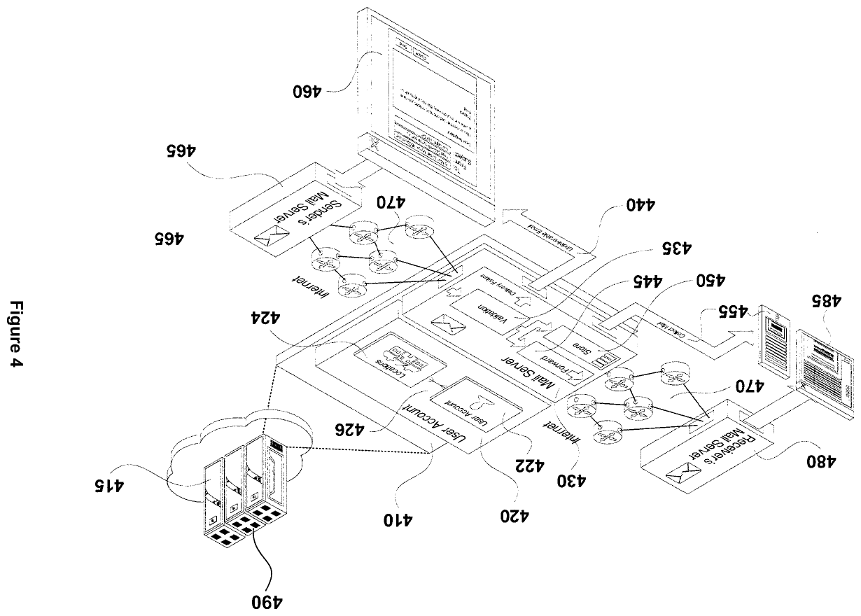

An additional computer application executed by the server (230) in the example of FIG. 2 is a mail server (238) which is described in greater detail with reference to FIG. 4.

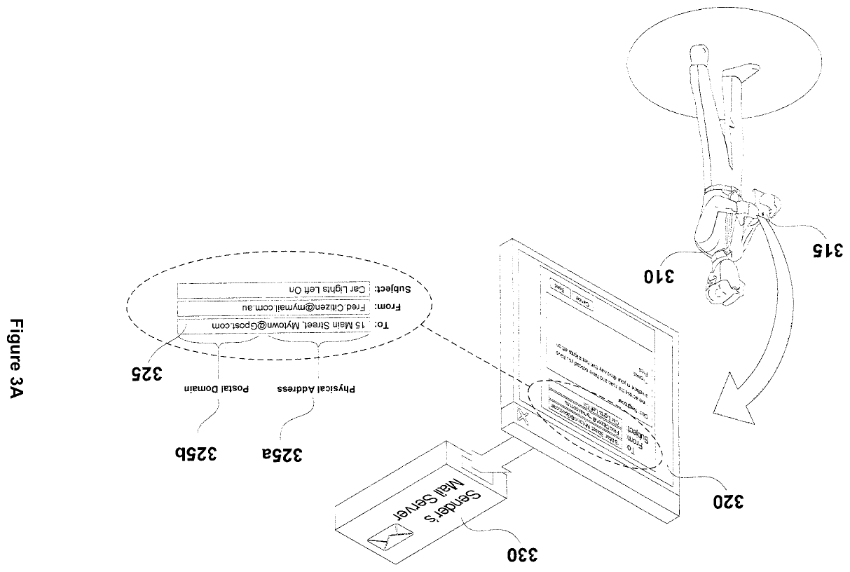

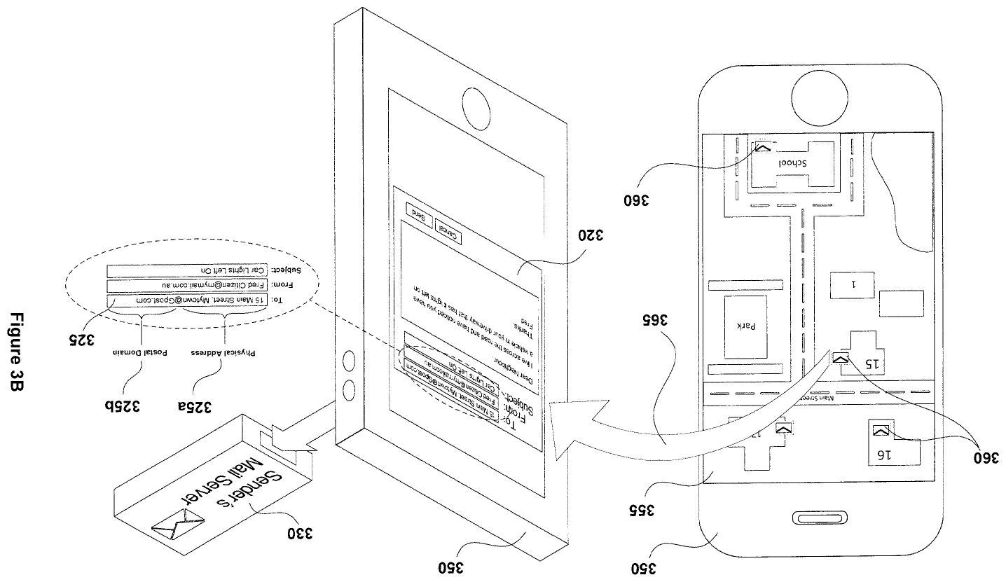

With reference to FIG. 3A, the steps involved in creating and addressing email correspondence for transmission to a fixed geographic location is illustrated. In this regard, a sender (310) operates an electronic communications device (315) which may include a Smartphone, a mobile computer or possibly a computing device located at a publicly accessible kiosk. Once the sender (310) operates an electronic communications device (315), the sender may compose an email using either a standard email client or the dedicated geographic email client. A standard email client of the type envisaged in FIG. 3A is generally known as a Mail User Agent (MUA) and common examples include Microsoft Outlook and Apple Mail. When seeking to send an email message to an address that is representative of a physical address (i.e. an example of a fixed geographic location), the sender (310) would address the email according to the predefined message address.

For example, in the example of FIG. 3A, the sender (310) composes an email and addresses the email to a fixed geographic location by addressing the email to:

### [Physical Address] @ [Postal Domain].

In the example of FIG. 3A, the sender (310) whilst operating their electronic communications device (315) is presented with a user interface (320) in which they are able to compose an electronic mail message and enter the address of a physical address to which the sender (310) seeks to send an electronic mail message. In the example of FIG. 3A, the physical address (325a) entered by the sender (310) is “15 Main Street, Mytown”. The postal domain (325b) is “Gpost.com” in the example of FIG. 3A and upon completing these details, the intended recipient field (325) is completed.

The “From” field will likely be autocompleted by the electronic communications device (315) and the email client initiated by the sender (310) and the sender (310) also completes the “Subject” field which in the example in FIG. 3A is completed with the text “Car Lights Left On”.

Upon completion of all the required fields, the sender (310) may elect to transmit the electronic mail message to the physical address identified in the “To” field (325) and the electronic mail message is transmitted to the sender's mail server (330).

With reference to FIG. 3B, an alternative method of transmitting email correspondence to a physical address is illustrated in which the sender (310) has caused a dedicated computer application to be executed on their electronic communication device (350) which in the example of FIG. 3B is a Smartphone.

In the example of FIG. 3B, the sender (310) is provided with a mapping application that provides the sender (310), which may be convenient to describe as an emergency service (e.g., a police officer responsible for selecting an area affected by civil unrest) with a display of available physical addresses (at fixed geographic locations) that are available for the purpose of transmitting electronic mail messages to those physical address. In the example of FIG. 3B, the sender is provided with a graphical display of physical locations in a plan view and overlaid on the physical locations is an icon (360) in the form of a graphical image of an envelope which when selected by a sender (310) causes the display of a subsequent user interface (320) consisting of a familiar display for the sender (310) to compose an email message although the address details of the intended recipient (325) consisting of a physical address (325a) and a postal domain (325b) has been automatically completed by the mapping application. Further, the sender's details are automatically completed for the sender (310) although the “Subject” field requires completion by the sender (310) along with the body of the electronic mail message.

As before for FIG. 3A, once the sender (310) has completed the electronic mail message for transmission to a physical address, the electronic mail message (320) is transmitted to the sender's mail server (330) for transmission to the system that operates the postal domain identified in the address field (325).

With reference to FIG. 4, the primary components of a system that processes and delivers electronic mail messages to fixed geographic locations is illustrated. As previously mentioned, the primary components illustrated in FIG. 4 may include one or more computer applications that are executed on local or cloud based infrastructure.

The system resides on server (410) which executes a number of computer applications to effect functions and includes three major components, namely, user account management (420) and the mail server (430) and location verification component (490). The user account management component (420) manages and maintains users who are registered with the system. Most importantly, the user management system (420) maintains a database of locations (426) and registered users who are associated in some way with the locations and who the system recognizes as having the requisite authority to receive electronic mail messages directed to those physical locations. The server (430) executes a number of computer applications to effect functions providing a location verification component (490), retaining and maintaining a database of fixed geographic locations and the users associated with each of those fixed geographic locations (424). Component 415 is the infrastructure on which the present invention operates and may be a local or cloud based infrastructure. Component (415) includes a series of sub-components including a user account management component (420); mail component (430); and a location verification component (490).

User account management component (420) manages the linkage or routing information between the server (430), a physical address and a recipient via their account. User account management component (420) keeps the ‘linkage’ between user and the physical locations for which they can receive emails—and for example, many-to-many (addresses) relationships are possible and are managed by the user account management component (420).

Location verification component (490) determines the geographic location of the sender via GPS with equipped devices. For non-GPS equipped devices (i.e. desktop computer) the devices IP address is used and compared against a geolocation database. It will also be appreciated by those skilled in the art that hybrid positioning systems may also be used including combinations of public IP address, cell tower IDs, GPS information, a list of WiFi access points, signal strengths and MAC addresses (WiFi and/or Bluetooth). For example, information may be passed to the location verification component (490) via an HTTPS request which attempts to correlate the recipients location from several databases that may include WiFi access point locations both public and private, as well as cell tower and IP address locations. A location may be returned via a callback, for example. In some embodiments, the location verification component (490) may be considered a location-based service (e.g. a software service that uses location data tied to a specific location where an emergency has taken place).

Location verification component (490) first carries out validation such that incoming mail is validated to ensure the mail can be correctly forwarded and to reduce SPAM. Location verification component (490) checks the mail for SPAM by only accepting mail with sender details in the metadata. This may, for example, include the sender location coordinates (e.g. latitude, longitude). In a second step, location verification component (490) checks the physical address to ensure that it can be identified. If the physical address is invalid then the mail will be returned to the sender as ‘undeliverable’. In an alternative, if there is no registered recipient at the physical address the mail could also be returned as ‘undeliverable’.

The mail is then stored or forwarded via email based on the address. Mail that can be delivered will be either be forwarded onto the recipient(s) or stored for later collection by the recipient(s)—such as via email or the like. If the mail remains uncollected the mail may returned to the sender as ‘undelivered’. Additionally the sender may also be notified if mail has been forward to or collected by a recipient.

Advantageously, the present invention, by validating the geographic location of the sender with GPS in real-time avoid SPAM and provides bandwidth savings. For example, the system can remove people from the network who send promotional emails as spam; and current email service providers are getting more stringent with suspicious emails and are relocating them to SPAM folders. Requiring more memory and processing power. The present invention largely obviates that need. The system may remove people from the network who send promotional emails as spam by way of a rating option available to the recipient when they receive mail. If a Sender is receiving poor rating responses e.g. SPAM or their mail is being sent to junk mail, they can be blacklisted from the system. In addition, the system can be limited to work in a geographic area (i.e. Australia) which then automatically eliminates a Sender trying to send from overseas or route through another country.

For example, in traditional ‘email’ a sender may have a dynamic IP address and their location would not be known. This is paramount for present invention in that that the sender has a location with longitude and latitude or via actual IP address aaa.aaa.aaa.aaa.

Traditional email operates by use of use of electronic mailboxes, which are routed from server to server. It uses a Mail Transport Agent (MTA) to transport email and the senders MTA is responsible and/or tasked with sending email to a recipients MTA. The present invention further provides more stringent user account information (i.e. sender information) together with a location verification component 490 such that sender emails location verified or updated with longitude and latitude; via actual IP address aaa.aaa.aaa.aaa. This is determined via the GPS that are device equipped. For non-GPS equipped devices (i.e. desktop computer) the devices IP address is used.

The mail server component (430) processes and delivers email correspondence according to the physical address to which the electronic mail correspondence is addressed and according to a predefined message address format.

The initial step in processing electronic mail correspondence according to the system illustrated in FIG. 4 is the step of validation. In this regard, incoming email correspondence (460) that has been composed and transmitted by a sender to their own email server (465) which is subsequently transmitted to the mail server (430) through a data communications network such as the Internet (470) undergo a validation process to ensure that the email can be forwarded to only those at a specific geographical location.

The validation process also has the effect of reducing the incidence of SPAM email since any email correspondence that fails the validation step is discarded. Routing of the mail when the message is sent from the senders computer with an associated IP Address to the Location Verification component (430) a message is directed back to the sender to verify their location via GPS.

Advantageously, there are significant bandwidth and server utilisation savings made by only sending email to recipients in a particular geographic location. So, for example, a business located in a particular geographic location, instead of sending an email to thousands of email addresses, a message is only directed to recipients who are located in that geographic location. This results in simpler and more cost effective IT infrastructure (i.e. fewer mail servers, requiring less memory and processing power). The present invention may, via the location verification component (490) validate the geographic location of the sender with GPS (in real-time) to avoids SPAM and provide further bandwidth savings. The present invention avoids senders from the network who send promotional emails as spam since, as a sender, it is not possible to misrepresent your geographical location and send beyond a particular geographical area—unless authorized.

In this regard, email correspondence may be designated as SPAM where the email correspondence does not include any sender details in the metadata in the email message. In an embodiment of the invention, the sender details may include the sender's location (latitude, longitude) which provides an increased level of scrutinisation of email correspondence processed by the mail server (430). Subsequently, the physical address to which the email correspondence is intended to be delivered is checked to ensure that the fixed geographic location identified in the email correspondence can be identified. In the event the physical address is invalid, then the email correspondence is returned to the sender as “undeliverable” (440). In an embodiment, in the event that there is no registered recipient for a particular physical address, the email correspondence is returned to the sender as “undeliverable” (440).

Once an email message is validated, the next step is to store, or forward, the email. In the first instance, all email correspondence is stored in the email message account associated with physical addresses and in the event that a recipient has provided a private email address for the “on-forwarding” of email messages arriving into the electronic message account for the physical location with whom the recipient is associated, any received email correspondence is forwarded to the private email address of the recipient. The storage of electronic mail messages (450) in electronic message accounts enables recipients to access the email store (450) to access and retrieve email correspondence transmitted to the intended recipient.

In the instance that a recipient has provided their private email address for the purpose of “on-forwarding” electronic mail received by the mail server (430), the email message is on forwarded (445) and transmitted by means of a data communications network such as the Internet (470) to the recipient's mail server (480). The recipient's mail server (480) processes the received electronic mail and once the recipient accesses their mail server (480), the recipient is provided with a display of the electronic mail message (485).

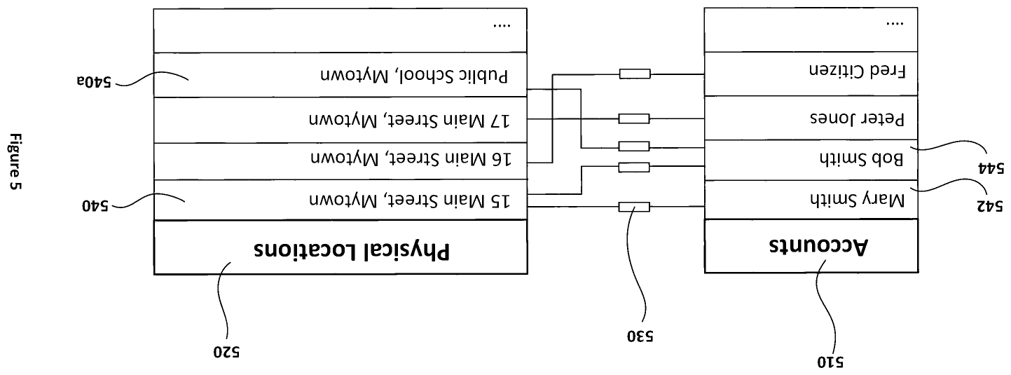

With reference to FIG. 5, a diagrammatic illustration is provided detailing the different types of relationships that may exist between electronic message accounts (510) and physical locations (520) that are managed by the system. In the example illustrated in FIG. 5, electronic message account holders Mary Smith (542) and Bob Smith (544) have relationships (530) with various physical locations (520) identified in the table.

For example, Mary Smith (542) has a sole relationship with the physical location of 15 Main Street, Mytown (540). However, Bob Smith (544) has two relationships (530) with physical locations, namely, 15 Main Street, Mytown (540) being his primary residence and also, Public School, Mytown (540a) since Bob Smith (544) is a school teacher and is an occupant of the physical location Public School, Mytown (540a) during business hours whereas outside of business hours Bob Smith (544) occupies the residence at 15 Main Street, Mytown (540).

In the instance of Bob Smith (544), he is interested in receiving electronic mail correspondence addressed to his personal residence (540) and also the premises of the school at which he is a school teacher (540a).

In an embodiment, the system stores additional information regarding the relationship between a registered user and a physical location such as the status of the relationship, for example, whether the relationship is current or historic, the commencement date of the relationship, the cessation date of the relationship and any other useful information.

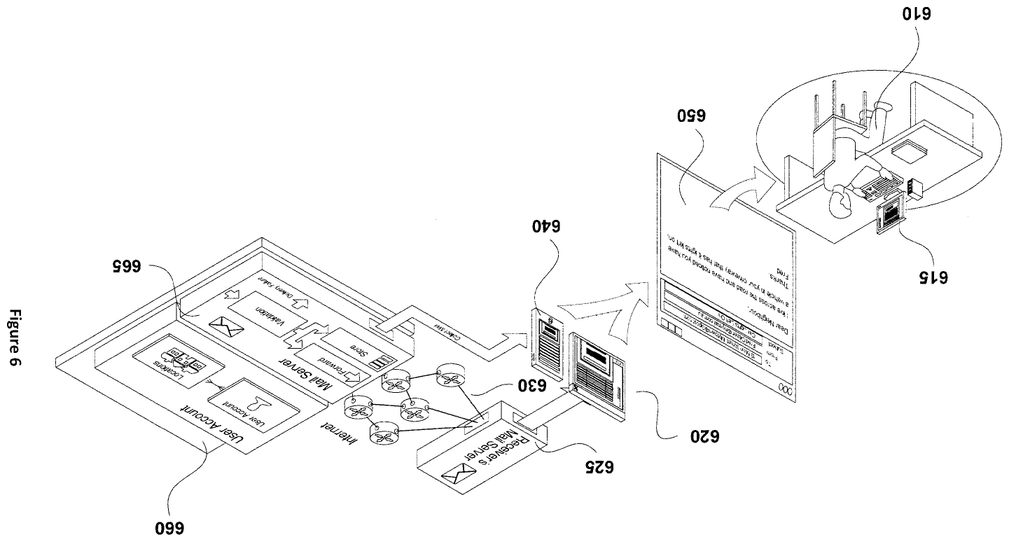

With reference to FIG. 6, the primary components associated with a recipient receiving email correspondence directed to a physical address with which the recipient has a registered association is illustrated. In this example, the recipient (610) accesses their electronic communication device (615) and either accesses their private email account for the purpose of collecting electronic mail correspondence transmitted to the physical address with which they are associated. Alternatively, the recipient (610) may use their electronic communications device (615) to access their electronic message account associated with the physical address with which the recipient (610) is associated for the purpose of retrieving the relevant electronic messages for the physical address.

In the instance of accessing the electronic message store, once accessed, the electronic mail messages (640) are downloaded from the mail server (665) and are displayed on a recipient user interface (650) thereby enabling the recipient (610) to review the electronic mail correspondence directed to the physical address with which the recipient (610) has registered an association.

Alternatively, the recipient (610) may operate their electronic communications device (615) to access their email server (625) and upon so doing, the receiver's mail server (625) will download any electronic mail correspondence that has yet to be accessed or downloaded (620) and the electronic mail correspondence is displayed to the user in a familiar display (650) thus enabling the recipient (610) to review the contents of the email correspondence.

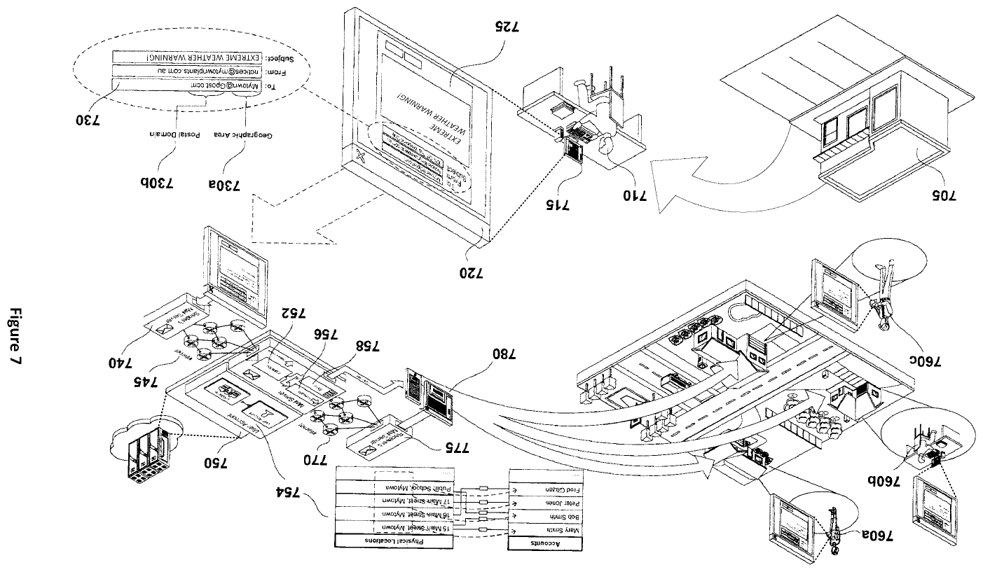

With reference to FIG. 7, a diagrammatic representation of a system and method according to the embodiment of FIG. 1 is provided in which a sender sends an electronic message to a plurality of physical addresses associated with fixed geographic locations. In FIG. 7, an emergency service (705) is illustrated which is representative of any emergency service such as a police station, a fire brigade or a government department.

In the example of FIG. 7, the emergency service (705) is interested in sending an electronic message or email correspondence to persons visiting or residents within a specific physical distance from the geographic location of a particular event. There are many examples of emergency services interested in sending correspondence to residents within a geographic region and one example is a meteorology office who seeks to warn residents within a certain region of an extreme weather event, such as a thunderstorm, or high risk of thunderstorm asthma.

The emergency service (705) employs a staff member (710) who operates an electronic communications device (715) such as a personal computer, mobile phone or computer tablet and prepares an electronic message or email correspondence for transmission to residential addresses within a preferred geographic region or to persons visiting that region. In the particular example of FIG. 7, the staff member (710) composes email correspondence using the familiar display (720) of an email provided by an email client such as Microsoft Outlook or a dedicated geographic email client provided by the system. It will be appreciated, that this can be effected by a mapping application that enables the staff member (710) to identify the geographic locations by reference to a mapping application.

Once the staff member (710) has composed the email message, they elect the geographic region to which they prefer to send the correspondence and in the example of FIG. 7, the staff member (710) addresses the email correspondence to an email address that relates to a plurality of persons visiting or physical addresses within a geographic region. In this regard, the addressee field (730) is completed with an email address according to the predefined message address format including a geographic area (730a) and a postal domain (730b). In some embodiments, the email address will be hidden from display so as not to burdening the user with the syntax, or semantics, of the information provided to, or sought by, a particular emergency service (e.g., the particular form of the email address as described above). As will be appreciated by skilled readers, an efficient user interface may be beneficial in an emergency. As described previously, the “From” field may be autocompleted and the “Subject” field is completed by the staff member (710) which in the example of FIG. 7 states “EXTREME WEATHER WARNING.”

Clearly, in the example of FIG. 7, the geographic area defined by the address (Mytown@Gpost.com) relates to a pre-defined geographic region such as all residential premises within a five kilometre radius of the geographic location of the centre of the thunderstorm. However, as will be appreciated by skilled readers, other potential examples of how this could be achieved are set out below in Table 1 which includes definitions of geographic areas such as Council regions or Electorates, user defined geographic regions such as a fixed geographic location and a radius and also the possibility of a geographic area bounded by points defined by the latitude and longitude details of each point forming a geographic region defined by a polygon. The present invention may via the location verification component (490) for example, determine that a user has entered a geographic area in real-time, for targeted warnings and the like. The present invention may, via the location verification component (490) validate the geographic location of the sender with GPS (in real-time) to avoid SPAM and provide further bandwidth savings. The present invention avoids senders from the network who send SPAM since, as a sender, it is not possible to misrepresent your geographical location and send beyond a particular geographical area—unless authorized. A Government department, such as the Bureau of Meteorology responsible for issuing extreme weather warnings, may be an example of an authorized user.

TABLE 1

| Geographic Area | Example |
|---|---|
| Street | Main Street, Mytown@Gpost.com |
| Town or Suburb | Mytown@Gpost.com |
| State | Victoria@GPost.com |
| Country | Australia@GPost.com |
| Council or Electorate | Mountain Shire@GPost.com |
| Region | MytownCBD@GPost.com |
| Point + Radius 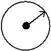 | 20 High Street, Mytown + 1km@GPost.com [Latitude, Longitude] + 1km@GPost.com |
| Area bounded by Points | [Latitude, Longitude], [Latitude, |
| | Longitude], [Latitude, Longitude], |
| | [Latitude, Longitude], [Latitude, |
| | Longitude] @GPost.com |
| Campus or complex of a | Government Complex X@GPost.com |
| University or company, or | |
| government entity. | |

Once the electronic message, in this case email correspondence is completed by the staff member (710), the email client transfers the email to the sender's mail server (740) which then routes the email according to the postal domain through an electronic data communications network such as the Internet (745). In the instance that the sender's mail server routes the email message to the dedicated geographic email service (750) the sender's email server is known as the sender's Mail Delivery Agent (MDA).

The dedicated geographic email service (750) first validates (752) incoming email correspondence to ensure that it is not SPAM (according to predefined rules including weather a particular user has had their location verified) and that the email can be correctly distributed. In the particular example of FIG. 7, this step may also include ensuring that the sender is authorised to send messages to any geographic location and has paid any requisite fee for the purpose of sending email correspondence to that location. Further, the geographic region to which the sender is attempting to send email correspondence is checked to ensure that it can be accurately identified. In the event that either of these steps results in a failure then the email correspondence is returned to the sender as “undeliverable.”

The dedicated geographic email service (750) subsequently uses the user account and registered location data (754) to identify all recipients of the email correspondence. In an embodiment, this is achieved by determining the registered physical addresses that fall within the geographic region defined by the sender and subsequently forwarding (756) or storing (758) the email correspondence for all recipients visiting or registered at the physical addresses in the geographic region.

In an embodiment, recipient preferences restrict the type of email correspondence they receive and in an example, a residence including three recipients may have user preferences defined for each of the recipients to either receive, or reject, weather events or other messages as they are move from one geographical location to another. For example, only one of the recipients at a particular physical residence may prefer to receive thunderstorm asthma warnings from the emergency service (705) whereas the remaining two recipients may not be susceptible to asthma (705).

In the example of FIG. 7, multiple recipients are illustrated (760a, 760b and 760c) who each receive the correspondence transmitted to physical addresses with which each of the recipients (760a, 760b and 760c) are associated and each of the recipients (760a, 760b and 760c) receive the email correspondence transmitted by the staff member (710) regarding the advertisement of the extreme weather warning by the emergency service (705).

As previously described with reference to earlier Figures, in the example of FIG. 7 each of the recipients (760a, 760b or 760c) may either directly collect email correspondence from the dedicated geographic email service (750) by accessing the store (758) or alternatively, any one or more of the recipients (760a, 760b or 760c) may elect to provide the details of their private email address to the dedicated geographic email service (750) such that the service (750) may forward (756) email correspondence addressed to the physical residence with which the recipients are associated. In the event that recipients (760a, 760b or 760c) prefer to receive email correspondence “on-forwarded”, the email correspondence is transmitted through an electronic data communications network such as the Internet (770) to the recipient's email server (775) and upon a recipient accessing their email server (775) the recipient receives the email correspondence at their email client (780) and may read the contents of the email correspondence.

In some embodiments, the electronic message or email correspondence transmitted through the Internet will appear to recipients (760a, 760b or 760c) as a “feed”. As will be appreciated, a feed is a way to publish emergency information in a structured format that facilitates identification and analysis. A feed can contain metadata about the emergency (e.g. subject, data, issuer, verification of the issuer, location that the emergency information relates to). These features of feeds make it easier for applications to automatically collect and evaluate the emergency information for content and the like for presentation to the user. In some embodiments, particularly those involving two-way communication, it will be particularly beneficial for an application to automatically collect and group emergency information, for example those relating to an extreme weather event or outbreak of fire in a particular location. In some embodiments, the message content may be parsed and grouped for presentation to a user based on location or key terms within the content or prioritised based on location. In this way, the present invention may provide a direct avenue of communication to residents at a particular location that may require rescue or assistance.

In some embodiments, a browser determines that the electronic message or email contains feed attributes and enables the user to view it in a user-friendly way. In some embodiments, feed attributes and electronic messages or emails are stored in a repository that is accessible by applications (e.g., by a dedicated geographic email client) that are used to view the feed and allow users to pull content from the feed for later retrieval. Users may also pull content from any device connected to the internet (e.g., devices connected to an internet via a wired connection). Advantageously, in a significant event, where the decentralized nature of mobile networks means that geographic regions can be rendered unavailable by increased call volume (or physical destruction of mobile network infrastructure), users connected to the internet via a wired connection can still receive push notifications from emergency services and the like. Furthermore, using wired network connections may free up voice capacity, which may otherwise be disrupted or delayed due to spectrum congestion, for emergency services at the scene of the significant event.

As will be appreciated, the present invention may allow a government to create an emergency override enabling the public to access electronic messages via WiFi from any wired network. By providing such a feed, in the event of a significant event (e.g., a terror attack or bush fire) the government may provide reliable, targeted and authenticated information to those at risk, by geographic location. Furthermore, the closed and dedicated nature of the present invention means that it is less susceptible to misinformation, such as that encountered on social media.

The feed may also contain automated responses and updates, for example, an emergency services coordinator may automatically acknowledge the successful reception of a message by transmitting an acknowledgement message that will appear in a user's feed. Similarly, updates may be sent to confirm services are en-route and the like. Providing trackable, time sensitive records of developments as they happen, may give confidence to users, particularly those panicked by a terror attack or bush fire.

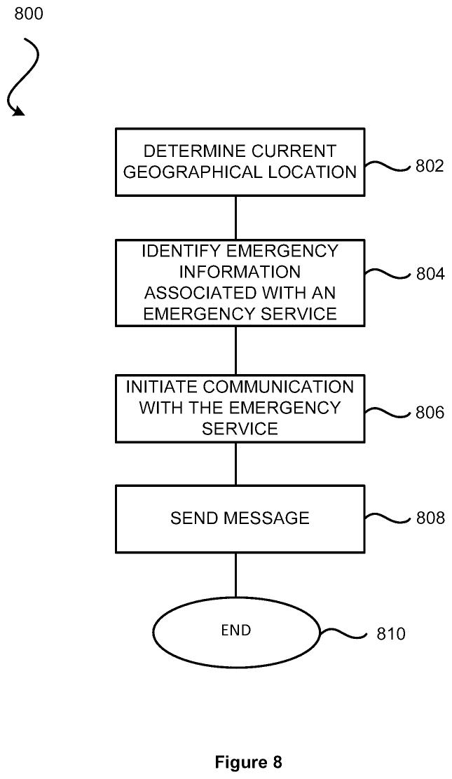

FIG. 8 illustrates a process (800) for communicating location-based emergency information to an emergency service. For convenience, the process (800) will be described in reference to a device (e.g., device 215) that performs the process (800). The device (215) is shown as a non-mobile device (e.g., a desktop computer fixed at a particular location). However, it should be appreciated that the device (215) may be any type of computing device that is non-mobile or mobile (e.g., a mobile phone).

The process (800) begins from the device (215) and by the server (230) when a current geographic location of the device is determined (802). The device (215) obtains its current geographic position. In some embodiments, the current location is determined by the device's (215) IP address used and compared against a geolocation database accessed by a component of the server (230). Hybrid positioning systems can also be used including combinations of IP addresses, cell tower IDs, GPS information, lists of WiFi access points, signal strengths and MAC addresses (WiFi and/or Bluetooth). For example, information can be passed to the location verification component (490) via an HTTPS request which attempts to correlate the recipients location from several databases that may include WiFi access point locations both public and private, as well as cell tower and IP address locations, and any other suitable technologies. A location can be returned via a callback, for example. In some embodiments, the device (215) determines its current location using only GPS or any other positioning system.

The current location, may be expressed in latitude and longitude with a component of the server (230) retaining and maintaining a database of fixed geographic locations to convert the current location to an address (e.g., country, state, city, address, venue, campus of a university, complex of a company, or government entity). The address may be returned via a callback, for example, by referencing a database of latitudes and longitudes and addresses stored in the database. As will be appreciated by skilled readers, determining the current location by way of a method that does not require a user to use conventional input such as a map or mapping application, may be beneficial in an emergency, particularly where a user is lost, disorientated or confused. By way of example, such a scenario may occur after a car accident where people may be in such a state of panic that it might be difficult to describe their location or situation. It will be appreciated that victims of domestic abuse or victims of any violent attack may be in a similar state of panic.

After the location is obtained, emergency information associated with an emergency service available at the current location is received (804), either directly provided by the server (230), or provided via a location-based service. Where the emergency information is provided via a location-based service, the device (215) sends a request to retrieve information at a universal resource locator (URL) associated with the location-based service. The emergency information can include an email address and/or phone number and an indication of the emergency service, entity or person with which the email address and/or phone number are associated. Several emergency services or emergency contacts may be received, for example, if it is determined that the device (215) is at a university campus, an emergency service (e.g., the police), campus security and building management emergency information may each be received.

In some embodiments, the emergency information may include other types of information for the determined geographic location (e.g., non-emergency police information, weather services, human services, rangers, etc.), contact information for utilities (e.g., electricity, water), and the like.

In some embodiments, the emergency information will be hidden from display so as to provide a convenient conduit to the emergency service without burdening the user with the syntax, or semantics, of the information provided to, or sought by, a particular emergency service (e.g., the particular form of the email address as described in previous embodiments). As will be appreciated by skilled readers, a simple, discreet (i.e., potentially silent) and efficient user interface may be beneficial in an emergency, particularly one that does not require a user to use conventional input such as voice, or keypad invocations, to a tree menu prompt interface as may be the case when calling an emergency phone number, for example “000” in Australia. In some embodiments, the device (215) can include a user interface where a user of the device can initiate communication of an “emergency” (potentially with a pre-set message, such as an SOS message) by pressing a button. Advantageously, this may also improve the labour costs and efficiency of emergency response.

Furthermore, the present invention may provide a ‘silent’ alternative to dialling emergency services when caught in a violent or abusive situation. Advantageously, victims of domestic abuse or victims of any violent attack, for example, may engage in discrete two-way conversation with emergency services (e.g., the police) informing them that they are in danger without the attacker's knowledge.

In some embodiments, the emergency information may include an email address and/or phone number and contact information for an embassy or consulate providing emergency services or consular assistance to travellers. The device (215) can include a user interface where a user of the device (215) can select a “home country” of the device. For example, if the device (215) is predominantly used in Australia, a user may select “Australia” as the “home country”. The device (215) can use the designated “home country” in a request retrieve the emergency information.

For example, if the home country of the device (215) is set to “Australia” and the device (215) requests emergency services in Pattaya, Thailand, the server (230) or location-based service can send the emergency information for the Australian Embassy in Bangkok, which is the Australian embassy nearest to Pattaya (the current geographic location of the device 215). If the same device is moved to Phuket, because the user of the device (215) is travelling, the server (230) or location-based service can send the emergency information for the Australian Consulate-General in Phuket, which provides Australian consular support nearest to Phuket (the new geographic location of the device 215). Here, in addition to having rapid access to emergency services, the user is also spared the burdensome task of determining emergency contact information for destinations before travelling.

After the emergency information associated with an emergency service available at the current location is received, communication is initiated between the device (215) using the identified emergency information (806). With reference to the embodiment of FIG. 1 and in particular, the components encircled with fixed outline 30 which are the components involved in the process of creating, or composing, an electronic mail message using either a standard email client or the dedicated geographic email client of the embodiment, an electronic email message can be sent to one or more emergency services. However, as will be appreciated by skilled readers the electronic messages are not limited to a standards-based email service.

The electronic message contains the geographic location of the device (215), which may be parsed or otherwise extracted from metadata by the emergency service (e.g., by a dedicated geographic email client).

In some embodiments, the device (215) can include a user interface where a user of the device can include supporting text or photos in their communication of an emergency. Emergency services may also parse this information to build a “snap-shot” of any escalating emergency based on the frequency of messages, parsing text or images contained in the messages, concentration of messages from a particular location or venue, and the like. Emergency services can now act at (810) or initiate further information via two-way communication.

An example scenario of use of the method and system according to an embodiment of the invention is provided below.

Several users, each having a device (215) are working within a government complex, some users report hearing explosions. No push notifications have been received by the dedicated geographic electronic mail service they subscribe to (as described with reference to FIGS. 1 to 7). Accordingly, a first user on a mobile device (215) decides to report the explosions to emergency services.

The location of the device (215) is determined via a hybrid positioning technology using a combination of public IP address (desktop devices) and/or cell tower ID (mobile devices). The location is then sent to a location-based service via a URL and the device's (215) location is returned via a callback as “Government Complex X”. Corresponding emergency information is also returned by reference to a database hosted by the service (e.g. server component 490), each emergency service includes a unique identifier of the relevant police department, “Government Complex X” building security, and an evacuation officer who also works within the complex. The specific details of the emergency services are hidden from display on the device (215) so as not to burden the user with the semantics, of the information provided to, or sought by, a particular emergency service. Thus, the user is quickly able to compose a message reporting the explosion. The message is then communicated to the relevant police department, “Government Complex X” building security, and the evacuation officer. The message has the geographic location of the device (215), “Government Complex X” appended to it as custom field in an SMTP header extension-field, before the message is sent as a standards-based email over the mobile network, WiFi, or the like. Confirmation that the sender's location has been verified is also included in the header, this provides the recipients with confirmation that the report is actually coming from within “Government Complex X” and has not been spoofed. The user receives a push notification that the message has been received via conventional methods.

Meanwhile, several other users, each having a device (215), report the explosions at the government complex. The frequency of which the messages are received indicates to the evacuation officer that it may be timely to remind occupants of the complex's evacuation plan. The evacuation officer is able to compose a message to only those within the complex as set out in the example of FIG. 7. Each user receives a push notification by the dedicated geographic electronic mail service and they each download a copy of the evacuation plan to their device (225) via a pull request.

The situation escalates, and it is determined that evacuation is necessary. Advantageously, each user has a copy of the evacuation plan on their device (225) and is no longer reliant on a network connection in the event of network congestion or power outage.

Another example scenario of use of the method and system according to an embodiment of the invention is provided below.

An Australian traveller, with a device (215), is in Thailand when civil unrest (terrorist attack, or the like) breaks out in his vicinity. The traveller, having previously set his home country to “Australia” (according to an embodiment described with reference to FIG. 8) receives a push notification by the dedicated geographic electronic mail service the traveller subscribes to (as described with reference to FIGS. 1 to 7). The push notification is from the Australian Embassy in Bangkok, with guidelines on what to do in the event of civil unrest, and details of areas to avoid. The traveller downloads a copy of the evacuation plan to their device (225) via a pull request. The Australian Embassy in Bangkok receives confirmation that the device is located in Thailand via the location verification component (240) and updates their records of persons potentially affected by the civil unrest accordingly.

On the back of the advice received by the Australian Embassy in Bangkok, the traveller leaves Thailand for Singapore. In Singapore, the traveller loses his passport. The traveller decides to report the lost passport to the local police. The location of the device (215) is determined via GPS. The location is then sent to a location-based service via a URL and the device's (215) location is returned via a callback as an address in Singapore. Corresponding emergency information is also returned by reference to a database hosted by the service (e.g. server component 490), each emergency service includes a unique identifier of the local police and the Australian Embassy in Singapore. The traveller realises that the Australian Embassy is probably a better resource to help with his lost passport. By way of a user interface the traveller is able to send a message to the Australian Embassy in Singapore only, and not the local police. The user is quickly able to compose a message reporting the lost passport. The message is then communicated to the Australian Embassy in Singapore as outlined above. Confirmation that the sender's location has been verified is also included in the message, this provides the Australian Embassy with confirmation that the device is now in Singapore. The Australian Embassy updates their records of persons potentially affected by the civil unrest in Bangkok accordingly.

Again, with reference to FIG. 1, a diagrammatic representation of an example system and method according to a second embodiment of the invention is illustrated in which a sender creates an electronic communication, and sends same to a dedicated geographic electronic mail client with the intended recipient identified in accordance with a predefined address format where the electronic mail address is associated with a fixed geographic location for retrieval by a receiver residing in, or associated with, the fixed geographic location.

All of the components illustrated in FIG. 1 are represented in greater detail in subsequent FIGS. 2 to 6 and the primary components of the system illustrated in FIG. 1 are described below.

The components encircled with fixed outline 20 are the components associated with the registration process that enables users to register their electronic mail contact details and identify the fixed geographic location with which they are associated. Registration of a user with the dedicated geographic email client enables the user to receive/access email correspondence directed to an email account associated with the fixed geographic location.

The components encircled with fixed outline 30 are the components involved in the process of creating, or composing, an electronic mail message using either a standard email client or the dedicated geographic email client of the embodiment. The components in this section of FIG. 1 also illustrate a sender's user interface in which the sender includes an email address according to a predefined address format for transmitting the electronic mail message to an email account associated with the fixed geographic location to which the sender seeks to send an electronic mail message.

The components encircled by fixed outline 35 illustrate the components for an alternative process for composing an email message in which the sender initiates an email client on a mobile electronic communication device such as a Smartphone or a computer tablet and the dedicated geographic email client assists the sender to determine the fixed geographic location to which the sender seeks to transmit an electronic mail message. This is effected by a mapping application that enables the sender to identify the fixed geographic locations by reference to the mapping application.

The components encircled by fixed outline 40 illustrate components of the system that receive sender requests regarding email messages and performs a range of functions including storing electronic mail messages in email accounts associated with fixed geographic locations to which an email message is addressed and further processing the electronic mail message by either storing, or forwarding, the email message for access by an intended recipient or, in the event that the electronic mail message is undeliverable, providing an appropriate message to the sender. This component of the system performs a range of additional functions including management of user accounts, resolving predefined addresses with respective fixed geographic locations and the storage and processing of user preferences in relation to users who have registered their electronic message contact details for receipt of email messages transmitted to a fixed geographic location with whom the user is associated.

The component illustrated in the encircled fixed outline 50 are examples of relationships that may exist between electronic message accounts and fixed geographic locations.

The components illustrated within the fixed outline 60 illustrate those components that process electronic mail messages for an intended recipient and in this regard, the intended recipient either receives the email message by the forwarding of same to their private email account or, the intended recipient may collect the email message by accessing the account associated with the fixed geographic location associated with the intended recipient for the purpose of viewing the electronic mail message.

The objects encircled by fixed outline 70 illustrate fixed geographic locations of both the sender and the intended recipient which, in the example of FIG. 1, the sender and the intended recipient are each associated with private residences that are located directly opposite one another somewhere in the world.

With reference to FIG. 2, a diagrammatic illustration is provided of a user (210) seeking to receive electronic mail messages transmitted to a fixed geographic location with whom the user is associated and in the example of FIG. 2, the user (210) is performing a registration process using their personal computer (215) such that they can access, or receive, electronic mail messages transmitted to the fixed geographic location with which they have some form of association.

In this regard, the association of the user (210) with a fixed geographic location may include the user (210) occupying a residence at the fixed geographic location, or the user (210) may occupy a fixed geographic location during office hours such as a business premises. Further, the user (210) may be the owner of a residence at a fixed geographic location and may be a landlord with tenants residing in the premises located at the fixed geographic location.

In any event, the user (210) initiates a registration process and provides some form of verification that they have the authority to receive email messages transmitted to the fixed geographic location. This process will likely vary from country to country and in some instances may include submitting evidence to the system that the user (210) has the requisite authority to receive email messages directed to a fixed geographic location by adducing documents evidencing the payment of council rates or perhaps providing an extract from the Land Titles Office which records the owner of residences and premises at fixed geographic locations. Of course, as part of this process, the user (210) should also verify their identity and this may be effected by a range of processes including well established proof of identity procedures which may involve the transmission of Out Of Band (00B) messages to the user's (210) Smartphone with a password or some other code requiring entry during the registration process to verify that the individual performing the registration process has the identity indicated during that registration process.

During this process, the user (210) is provided with a user interface (220) and the user (210) completes various fields identified within the user interface (220) including details such as a private email address to which the user would prefer incoming email messages to be forwarded (222) and of course, provision of the details of one or more physical address(es) for which the user (210) has the authority to collect email messages directed to the one or more physical addresses at fixed geographic locations (224).

Once the user (210) has completed all of the required fields in the user interface (220), the details are transmitted (226) to a computer server (230) which includes one or more computer applications.

In the example of FIG. 2, component 232 is the infrastructure on which the present invention operates and may be a local or cloud based infrastructure. Component 232 includes a series of sub-components a server (230) which executes a number of computer applications to effect functions such as creating and administering user accounts (234), retaining and maintaining a database of fixed geographic locations and the users associated with each of those fixed geographic locations (236). As will be appreciated by skilled readers, it is possible to have a “many-to-many” relationship between user accounts and fixed geographic locations at which residences and/or premises are located. Optionally, component 232 may further location verification component (240) which is be provided to verify the location of a user who, for example, wishes to send mail.

An additional computer application executed by the server (230) in the example of FIG. 2 is a mail server (238) which is described in greater detail with reference to FIG. 4.

With reference to FIG. 3A, the steps involved in creating and addressing email correspondence for transmission to a fixed geographic location is illustrated. In this regard, a sender (310) operates an electronic communications device (315) which may include a Smartphone, a mobile computer or possibly a computing device located at a publicly accessible kiosk. Once the sender (310) operates an electronic communications device (315), the sender may compose an email using either a standard email client or the dedicated geographic email client. A standard email client of the type envisaged in FIG. 3A is generally known as a Mail User Agent (MUA) and common examples include Microsoft Outlook and Apple Mail. When seeking to send an email message to an address that is representative of a physical address (i.e. an example of a fixed geographic location), the sender (310) would address the email according to the predefined message address.

For example, in the example of FIG. 3A, the sender (310) composes an email and addresses the email to a fixed geographic location by addressing the email to:

### [Physical Address] @ [Postal Domain].

In the example of FIG. 3A, the sender (310) whilst operating their electronic communications device (315) is presented with a user interface (320) in which they are able to compose an electronic mail message and enter the address of a physical address to which the sender (310) seeks to send an electronic mail message. In the example of FIG. 3A, the physical address (325a) entered by the sender (310) is “15 Main Street, Mytown”. The postal domain (325b) is “Gpost.com” in the example of FIG. 3A and upon completing these details, the intended recipient field (325) is completed.

The “From” field will likely be autocompleted by the electronic communications device (315) and the email client initiated by the sender (310) and the sender (310) also completes the “Subject” field which in the example in FIG. 3A is completed with the text “Car Lights Left On”.

Upon completion of all the required fields, the sender (310) may elect to transmit the electronic mail message to the physical address identified in the “To” field (325) and the electronic mail message is transmitted to the sender's mail server (330).

With reference to FIG. 3B, an alternative method of transmitting email correspondence to a physical address is illustrated in which the sender (310) has caused a dedicated computer application to be executed on their electronic communication device (350) which in the example of FIG. 3B is a Smartphone.

In the example of FIG. 3B, the sender (310) is provided with a mapping application that provides the sender (310) with a display of available physical addresses (at fixed geographic locations) that are available for the purpose of transmitting electronic mail messages to those physical address. In the example of FIG. 3B, the sender is provided with a graphical display of physical locations in a plan view and overlaid on the physical locations is an icon (360) in the form of a graphical image of an envelope which when selected by a sender (310) causes the display of a subsequent user interface (320) consisting of a familiar display for the sender (310) to compose an email message although the address details of the intended recipient (325) consisting of a physical address (325a) and a postal domain (325b) has been automatically completed by the mapping application. Further, the sender's details are automatically completed for the sender (310) although the “Subject” field requires completion by the sender (310) along with the body of the electronic mail message.

As before for FIG. 3A, once the sender (310) has completed the electronic mail message for transmission to a physical address, the electronic mail message (320) is transmitted to the sender's mail server (330) for transmission to the system that operates the postal domain identified in the address field (325), namely “Gpost.com.”

With reference to FIG. 4, the primary components of a system that processes and delivers electronic mail messages to fixed geographic locations is illustrated. As previously mentioned, the primary components illustrated in FIG. 4 may include one or more computer applications that are executed on local or cloud based infrastructure.

The system resides on server (410) which executes a number of computer applications to effect functions and includes three major components, namely, user account management (420) and the mail server (430) and location verification component (490). The user account management component (420) manages and maintains users who are registered with the system. Most importantly, the user management system (420) maintains a database of locations (426) and registered users who are associated in some way with the locations and who the system recognizes as having the requisite authority to receive electronic mail messages directed to those physical locations. The server (430) executes a number of computer applications to effect functions providing a location verification component (490), retaining and maintaining a database of fixed geographic locations and the users associated with each of those fixed geographic locations (424). Component 415 is the infrastructure on which the present invention operates and may be a local or cloud based infrastructure. Component 415 includes a series of sub-components including a user account management component (420); mail component (430); and a location verification component (490).

User account management component (420) manages the linkage or routing information between the server 430, a physical address and a recipient via their account. User account management component (420) keeps the ‘linkage’ between user and the physical locations for which they can receive emails—and for example, many to many (addresses) relationships are possible and are managed by the User account management component (420).

Location verification component (490) determines the geographic location of the sender via GPS with equipped devices. For non-GPS equipped devices (i.e. desktop computer) the devices IP address is used and compared against a geolocation database. It will also be appreciated by those skilled in the art that hybrid positioning systems may also be used including combinations of GPS, IP and cellular geolocation methods.

Location verification component (490) first carries out validation such that incoming mail is validated to ensure the mail can be correctly forwarded and to reduce spam. Location verification component (490) checks the mail for SPAM by only accepting mail with sender details in the metadata. This may, for example, include the sender location coordinates (e.g. latitude, longitude). In a second step, location verification component (490) checks the physical address to ensure that it can be identified. If the physical address is invalid then the mail will be returned to the sender as ‘undeliverable’. In an alternative, if there is no registered recipient at the physical address the mail could also be returned as ‘undeliverable’.

The mail is then stored or forwarded via email based on the address. Mail that can be delivered will be either be forwarded onto the recipient(s) or stored for later collection by the recipient(s)—such as via email or the like. If the mail remains uncollected the mail may returned to the sender as ‘undelivered’. Additionally the sender may also be notified if mail has been forward to or collected by a recipient.

Advantageously, the present invention, by validating the geographic location of the sender with GPS in real-time avoid SPAM and provides bandwidth savings. For example, the system can remove people from the network who send promotional emails as spam; and current email service providers are getting more stringent with suspicious emails and are relocating them to SPAM folders. Requiring more memory and processing power. The present invention largely obviates that need. The system may remove people from the network who send promotional emails as spam by way of a rating option available to the recipient when they receive mail. If a Sender is receiving poor rating responses e.g. SPAM or their mail is being sent to junk mail, they can be blacklisted from the system. In addition, the system can be limited to work in a geographic area (i.e. Australia) which then automatically eliminates a Sender trying to send from overseas or route through another country.

For example, in traditional “email”, a sender may have a dynamic IP address and their location would not be known. This is paramount for present invention in that that the sender has a location with longitude and latitude or via actual IP address aaa.aaa.aaa.aaa.

Traditional email operates by use of use of electronic mailboxes, which are routed from server to server. It uses a Mail Transport Agent (MTA) to transport email and the senders MTA is responsible and/or tasked with sending email to a recipients MTA. The present invention further provides more stringent user account information (i.e. sender information) together with a location verification component 490 such that sender emails location verified or updated with longitude and latitude; via actual IP address aaa.aaa.aaa.aaa. This is determined via the GPS that are device equipped. For non-GPS equipped devices (i.e. desktop computer) the devices IP address is used.

The mail server component (430) processes and delivers email correspondence according to the physical address to which the electronic mail correspondence is addressed and according to a predefined message address format.

The initial step in processing electronic mail correspondence according to the system illustrated in FIG. 4 is the step of validation. In this regard, incoming email correspondence (460) that has been composed and transmitted by a sender to their own email server (465) which is subsequently transmitted to the mail server (430) through a data communications network such as the Internet (470) undergo a validation process to ensure that the email can be forwarded to a physical address. The validation process also has the effect of reducing the incidence of SPAM email since any email correspondence that fails the validation step is discarded. Routing of the mail when the message is sent from the senders computer with an associated IP Address to the Location Verification component 430 a message is directed back to the sender to verify their location via GPS. Advantageously, there are significant bandwidth and server utilisation savings made by only sending email to recipients in a particular geographic location. So, for example, a business located in a particular geographic location, instead of sending an email to thousands of email addresses, a message is only directed to recipients who are located in that geographic location. This results in simpler and more cost effective IT infrastructure (i.e. fewer mail servers, requiring less memory and processing power). The present invention may, via the location verification component 490 validate the geographic location of the sender with GPS (in real-time) to avoids SPAM and provide further bandwidth savings. The present invention avoids senders from the network who send promotional emails as spam since, as a sender, it is not possible to misrepresent your geographical location and send beyond a particular geographical area—unless authorized.

In this regard, email correspondence may be designated as SPAM where the email correspondence does not include any sender details in the metadata in the email message. In an embodiment of the invention, the sender details may include the sender's location (latitude, longitude) which provides an increased level of scrutinisation of email correspondence processed by the mail server (430). Subsequently, the physical address to which the email correspondence is intended to be delivered is checked to ensure that the fixed geographic location identified in the email correspondence can be identified. In the event the physical address is invalid, then the email correspondence is returned to the sender as “undeliverable” (440). In an embodiment, in the event that there is no registered recipient for a particular physical address, the email correspondence is returned to the sender as “undeliverable” (440).

Once an email message is validated, the next step is to store, or forward, the email. In the first instance, all email correspondence is stored in the email message account associated with physical addresses and in the event that a recipient has provided a private email address for the “on-forwarding” of email messages arriving into the electronic message account for the physical location with whom the recipient is associated, any received email correspondence is forwarded to the private email address of the recipient. The storage of electronic mail messages (450) in electronic message accounts enables recipients to access the email store (450) to access and retrieve email correspondence transmitted to the intended recipient.

In the instance that a recipient has provided their private email address for the purpose of “on-forwarding” electronic mail received by the mail server (430), the email message is on forwarded (445) and transmitted by means of a data communications network such as the Internet (470) to the recipient's mail server (480). The recipient's mail server (480) processes the received electronic mail and once the recipient accesses their mail server (480), the recipient is provided with a display of the electronic mail message (485).

With reference to FIG. 5, a diagrammatic illustration is provided detailing the different types of relationships that may exist between electronic message accounts (510) and physical locations (520) that are managed by the system. In the example illustrated in FIG. 5, electronic message account holders Mary Smith (542) and Bob Smith (544) have relationships (530) with various physical locations (520) identified in the table.

For example, Mary Smith (542) has a sole relationship with the physical location of 15 Main Street, Mytown (540). However, Bob Smith (544) has two relationships (530) with physical locations, namely, 15 Main Street, Mytown (540) being his primary residence and also, Public School, Mytown (540a) since Bob Smith (544) is a school teacher and is an occupant of the physical location Public School, Mytown (540a) during business hours whereas outside of business hours Bob Smith (544) occupies the residence at 15 Main Street, Mytown (540).

In the instance of Bob Smith (544), he is interested in receiving electronic mail correspondence addressed to his personal residence (540) and also the premises of the school at which he is a school teacher (540a).

In an embodiment, the system stores additional information regarding the relationship between a registered user and a physical location such as the status of the relationship, for example, whether the relationship is current or historic, the commencement date of the relationship, the cessation date of the relationship and any other useful information.

With reference to FIG. 6, the primary components associated with a recipient receiving email correspondence directed to a physical address with which the recipient has a registered association is illustrated. In this example, the recipient (610) accesses their electronic communication device (615) and either accesses their private email account for the purpose of collecting electronic mail correspondence transmitted to the physical address with which they are associated. Alternatively, the recipient (610) may use their electronic communications device (615) to access their electronic message account associated with the physical address with which the recipient (610) is associated for the purpose of retrieving the relevant electronic messages for the physical address.

In the instance of accessing the electronic message store, once accessed, the electronic mail messages (640) are downloaded from the mail server (665) and are displayed on a recipient user interface (650) thereby enabling the recipient (610) to review the electronic mail correspondence directed to the physical address with which the recipient (610) has registered an association.

Alternatively, the recipient (610) may operate their electronic communications device (615) to access their email server (625) and upon so doing, the receiver's mail server (625) will download any electronic mail correspondence that has yet to be accessed or downloaded (620) and the electronic mail correspondence is displayed to the user in a familiar display (650) thus enabling the recipient (610) to review the contents of the email correspondence.

With reference to FIG. 7, a diagrammatic representation of a system and method according to the embodiment of FIG. 1 is provided in which a sender sends an electronic message to a plurality of physical addresses associated with fixed geographic locations. In FIG. 7, a business premises (705) is illustrated which is representative of any business such as a retail outlet, a company office, a government department or an individual sole practitioner business.

In the example of FIG. 7, the business premise (705) is interested in sending email correspondence to residents within a specific physical distance from the geographic location of the business premises (705). There are many examples of businesses interested in sending correspondence to residents within a geographic region and one example is a fast food restaurant with a take away menu who seeks to provide their menu of prices to residents within a walking distance or a reasonably short drive time to the business premises (705).

The business (705) employs a staff member (710) who operates an electronic communications device (715) such as a personal computer, mobile phone or computer tablet and prepares email correspondence for transmission to residential addresses within a preferred geographic region. In the particular example of FIG. 7, the staff member (710) composes email correspondence using the familiar display (720) of an email provided by an email client such as Microsoft Outlook or a dedicated geographic email client provided by the system.

Once the staff member (710) has composed the email message, they elect the geographic region to which they prefer to send the correspondence and in the example of FIG. 7, the staff member (710) addresses the email correspondence to an email address that relates to a plurality of physical addresses within a geographic region. In this regard, the addressee field (730) is completed with an email address according to the predefined message address format including a geographic area (730a) and a postal domain (730b). As described previously, the “From” field may be autocompleted and the “Subject” field is completed by the staff member (710) which in the example of FIG. 7 states “10% Off This Weekend Only.”

Clearly, in the example of FIG. 7, the geographic area defined by the address (Mytown@Gpost.com) relates to a pre-defined geographic region such as all residential premises within a five kilometre radius of the fixed geographic location of the business premises (705). However, as will be appreciated by skilled readers, other potential examples of how this could be achieved are set out below in Table 2 which includes definitions of geographic areas such as Council regions or Electorates, user defined geographic regions such as a fixed geographic location and a radius and also the possibility of a geographic area bounded by points defined by the latitude and longitude details of each point forming a geographic region defined by a polygon. The present invention may via the location verification component (490) for example, determine that a user has entered a geographic area in real-time, for targeted marketing purposes. The present invention may, via the location verification component 490 validate the geographic location of the sender with GPS (in real-time) to avoid SPAM and provide further bandwidth savings. The present invention avoids senders from the network who send promotional emails as spam since, as a sender, it is not possible to misrepresent your geographical location and send beyond a particular geographical area—unless authorized.

TABLE 2

| Geographic Area | Example |
|---|---|
| Street | Main Street, Mytown@Gpost.com |
| Town or Suburb | Mytown@Gpost.com |
| State | Victoria@GPost.com |
| Country | Australia@GPost.com |
| Council or Electorate | Mountain Shire@GPost.com |
| Region | MytownCBD@GPost.com |
| Point + Radius 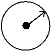 | 20 High Street, Mytown + 1km@GPost.com [Latitude, Longitude] + 1km@GPost.com |
| Area bounded by Points 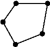 | [Latitude, Longitude], [Latitude, Longitude], [Latitude, Longitude], [Latitude, Longitude], [Latitude, Longitude] @GPost.com |

Once the email correspondence is completed by the staff member (710), the email client transfers the email to the sender's mail server (740) which then routes the email according to the postal domain through an electronic data communications network such as the Internet (745). In the instance that the sender's mail server routes the email message to the dedicated geographic email service (750) the sender's email server is known as the sender's Mail Delivery Agent (MDA).

The dedicated geographic email service (750) first validates (752) incoming email correspondence to ensure that it is not SPAM (according to predefined rules) and that the email can be correctly distributed. In the particular example of FIG. 7, this step may also include ensuring that the sender is authorised and has paid any requisite fee for the purpose of sending email correspondence including advertising material. Further, the geographic region to which the sender is attempting to send email correspondence is checked to ensure that it can be accurately identified. In the event that either of these steps results in a failure then the email correspondence is returned to the sender as “undeliverable.”

The dedicated geographic email service (750) subsequently uses the user account and registered location data (754) to identify all recipients of the email correspondence. In an embodiment, this is achieved by determining the registered physical addresses that fall within the geographic region defined by the sender and subsequently forwarding (756) or storing (758) the email correspondence for all recipients registered at the physical addresses in the geographic region.

In an embodiment, recipient preferences restrict the type of email correspondence they receive and in an example, a residence including three recipients may have user preferences defined for each of the recipients to either receive, or reject, advertising material. For example, only one of the recipients at a particular physical residence may prefer to receive advertising material from the business premises (705) whereas the remaining two recipients may dislike the food served by the restaurant (705).

In the example of FIG. 7, multiple recipients are illustrated (760a, 760b and 760c) who each receive the correspondence transmitted to physical addresses with which each of the recipients (760a, 760b and 760c) are associated and each of the recipients (760a, 760b and 760c) receive the email correspondence transmitted by the staff member (710) regarding the advertisement of the 10% weekend discount offer for the business (705).

As previously described with reference to earlier Figures, in the example of FIG. 7 each of the recipients (760a, 760b or 760c) may either directly collect email correspondence from the dedicated geographic email service (750) by accessing the store (758) or alternatively, any one or more of the recipients (760a, 760b or 760c) may elect to provide the details of their private email address to the dedicated geographic email service (750) such that the service (750) may forward (756) email correspondence addressed to the physical residence with which the recipients are associated. In the event that recipients (760a, 760b or 760c) prefer to receive email correspondence “on-forwarded”, the email correspondence is transmitted through an electronic data communications network such as the Internet (770) to the recipient's email server (775) and upon a recipient accessing their email server (775) the recipient receives the email correspondence at their email client (780) and may read the contents of the email correspondence.

As will be appreciated by skilled readers, a system and method according to the invention enables the transmission of electronic mail correspondence to fixed geographic locations (such as residential and business premises) thereby enabling users to send email correspondence to any physical address in the world. Users who are associated with one or more fixed geographic locations may register to receive such correspondence without divulging the details of their private email address to persons or entities potentially interested in sending correspondence to a residential or business premise with whom the recipient is associated.

The reference to any prior art in this specification is not, and should not be taken as, an acknowledgement or any form or suggestion, that the prior art forms part of the common general knowledge.

Throughout this specification and the claims which follow, unless the context requires otherwise, the word “comprise”, and variations such as “comprises” and “comprising”, will be understood to mean the inclusion of a stated integer or step, or group of integers or steps, but not the exclusion of any other integer or step or group of integers or steps.

1.-57. (canceled)

58. A system for sending one or more e-mail messages to one or more intended recipients, the e-mail messages having a predefined address format associated with a geographic location, the system including:
one or more processors; and
a computer-readable medium storing instructions for execution by the one or more processors, the instructions operable to cause the one or more processors to perform operations comprising:
receiving, from an electronic communication device and by a server, a request for accessing one or more emergency services;
determining, by the server, a current geographic location of the electronic communication device by using at least the device's IP address compared against a geolocation database accessed by a component of the server;
identifying, by the server, emergency information associated with an emergency service available at the geographic location;
initiating communication between the electronic communication device and the emergency service using the identified emergency information; and
communicating with the emergency service using the emergency information via one or more e-mail messages, wherein communicating with the emergency service includes sending, from the server, the geographic location of the electronic communication device and, based on the geographic location of the electronic communication device, sending one or more e-mail messages to one or more recipients associated with one or more further electronic communication devices associated with that geographical location.

59. A system according to claim 58, further comprising verifying, by the server, that the electronic communication device is actually located at the determined geographic location.

60. A system according to claim 58, wherein longitudinal and latitudinal geographic coordinates are used to associate the one or more e-mail messages with the geographic location.

61. A system according to claim 58, further including the step of verifying, by the server, that the electronic communication device is actually located at the determined current geographic location.

62. A system according to claim 58, further including the step of determining, by the server, a geographic location bounded by points defined by the latitude and longitude; details of each point forming a geographic region defined by a polygon.

63. A system according to claim 58, wherein longitudinal and latitudinal geographic coordinates are used to associate a predefined message address with a fixed geographic location.

64. A system according to claim 58, wherein the sender user interface is adapted to receive from the sender, at least one predefined message address in order to send one or more electronic messages to one or more electronic message accounts associated with respective fixed geographic locations, wherein the one or more recipients have access to the electronic message accounts.

65. A system according to claim 58, wherein the sender user interface is adapted to receive from the sender, any one of, or a combination of two or more of, the following information to select a plurality of fixed geographic locations, wherein each fixed geographic location is associated with a predefined message address:
a plurality of predefined message addresses;
one or more specified geographic regions including any one or more of the following: a street, a suburb, a postcode, a shire, a local council, a state, a region or a country;
a specified distance from a fixed point location to define a geographic region.

66. A system according to claim 58, wherein the processor is further adapted to automatically populate an electronic message with the predefined message addresses corresponding to any fixed geographic locations selected by the sender.

67. A system according to claim 58 wherein either one, or both, of the sender and recipient user interfaces is located on a computer, a laptop, a tablet or a mobile communication device.

68. A system according to claim 58, further comprising verifying, by the server, that the electronic communication device is actually located at the determined geographic location.

69. A system according to claim 58, wherein the geographic location of the electronic communication device is stored as metadata in the electronic message.

70. A system according to claim 58, wherein longitudinal and latitudinal geographic coordinates are used to associate the electronic message with the geographic location.

71. A system according to claim 58, further comprising resolving from the latitude and longitude geographic coordinates received from the electronic communications device a postal address associated with a user.

72. A system according to claim 58, wherein the emergency information comprises at least one of an email address, an identifier of a text message service, or a cell broadcast message service.

73. A method for sending one or more e-mail messages to one or more intended recipients, the e-mail messages having a predefined address format associated with a geographic location, the method including:
receiving, from an electronic communication device and by a server, a request for accessing one or more emergency services;
determining, by the server, a current geographic location of the electronic communication device by using at least the device's IP address compared against a geolocation database accessed by a component of the server;
identifying, by the server, emergency information associated with an emergency service available at the geographic location;
initiating communication between the electronic communication device and the emergency service using the identified emergency information; and
communicating with the emergency service using the emergency information via one or more e-mail messages, wherein communicating with the emergency service includes sending, from the server, the geographic location of the electronic communication device and, based on the geographic location of the electronic communication device, sending one or more e-mail messages to one or more recipients associated with one or more further electronic communication devices associated with that geographical location.

74. A system for sending one or more electronic messages to one or more intended recipients each having access to an electronic communication device, the electronic messages having a predefined address format, the one or more intended recipients being associated with one or more fixed geographic locations, the system including:
a sender user interface operable to enable a sender to create and send one or more electronic messages to one or more predefined message addresses;
a computer processor in communication with the sender user interface and configured to:
resolve the one or more predefined addresses with respective associated fixed geographic locations, and
forward the one or more electronic messages to one or more electronic message accounts associated with the one or more predefined addresses;
one or more recipient user interfaces operable to enable intended recipients, associated with one or more fixed geographic locations, to access the one or more electronic messages sent to the message accounts associated with the recipient's fixed geographic location.

75. A system according to claim 74, wherein the sender user interface is adapted to receive from the sender, any one of, or a combination of two or more of, the following information to select a plurality of fixed geographic locations, wherein each fixed geographic location is associated with a predefined message address:
a plurality of predefined message addresses;
one or more specified geographic regions including any one or more of the following: a street, a suburb, a postcode, a shire, a local council, a state, a region or a country;
a specified distance from a fixed point location to define a geographic region.

76. A system according to claim 74, wherein the sender is able to select a plurality of fixed geographic locations by the use of an electronic input device which is used to cast a virtual net over a selected geographic region, wherein each fixed geographic location within the selected geographic region is associated with a predefined message address.
